(19) United States
(12) Patent Application Publication
(10) Pub. No.: US 2026/0149373 A1
(43) Pub. Date: May 28, 2026

(54) Bootstrap Capacitor Refresh Control Apparatus and Method

(71) Applicant: Diodes Incorporated, Plano, TX (US)

(72) Inventors: Feng-Jung Huang, Taoyuan City (TW); Hao-Ming Chen, New Taipei City (TW); Ko-Yen Lee, New Taipei City (TW); Kuo-Yung Yu, New Taipei City (TW)

(21) Appl. No.: 18/958,586

(22) Filed: Nov. 25, 2024

(51) Int. Cl. H02M 3/157; H02M 3/158

(52) U.S. Cl. CPC H02M 3/157; H02M 3/158

(57) ABSTRACT

An apparatus includes a bootstrap capacitor refresh pulse generation circuit configured to generate a refresh pulse to turn on a low-side switch of a power converter once an off-time of the low-side switch exceeds a predetermined threshold, and a logic gate configured to receive the refresh pulse and a low-side pulse width modulation (PWM) signal, and generate a drive signal applied to a gate of the low-side switch of the power converter.

### TECHNICAL FIELD

The present disclosure relates generally to the field of power converters, and in particular embodiments, to techniques and mechanisms for maintaining a bootstrap capacitor voltage in a buck power converter.

### BACKGROUND

In power conversion systems, bootstrap capacitors are commonly utilized to establish a floating voltage higher than an input voltage. This technique is especially useful in circuits that require a higher voltage to drive high-side switches. For example, a driver integrated circuit (IC) is configured to drive a power converter comprising two power switches connected in series between an input voltage bus and ground, and an inductor connected between a common node of these two power switches, and an output voltage bus. The driver IC receives its operating voltage from a bias voltage source. In a typical system configuration, the driver IC includes a high-side driver and a low-side driver, responsible for driving the high-side switch and the low-side switch, respectively. A bootstrap capacitor is placed between a bias voltage node and a common node of the high-side switch and the low-side switch. This arrangement provides the required floating voltage for the high-side driver. In operation, when the low-side power switch is turned on, the bias voltage charges the bootstrap capacitor, thus replenishing the floating voltage needed for operation.

However, a significant issue arises in situations involving prolonged off of the low-side switch. Some control methods adjust the switching frequency or temporarily halt switching altogether. In such scenarios, the controller reduces or stops the turn-on of the low-side switch, effectively turning off the refresh path needed to recharge the bootstrap capacitor. When this refresh path remains inactive for extended periods, the bootstrap capacitor is unable to draw sufficient charge from the bias voltage, leading to a depletion of the floating voltage supply required for the high-side driver. This results in an insufficient power supply from the bootstrap capacitor, potentially causing the high-side switch to lose the necessary gate drive voltage, which may lead to circuit instability, reduced efficiency, or operational failure in the high-side driver. It would be desirable to have a simple bootstrap capacitor refresh control apparatus through which the bootstrap capacitor can be adequately charged, thereby providing a consistent high-side drive power supply. This disclosure addresses that need.

### SUMMARY

Technical advantages are generally achieved, by embodiments of this disclosure which describe a bootstrap capacitor refresh control apparatus.

In accordance with an embodiment, an apparatus comprises a bootstrap capacitor refresh pulse generation circuit configured to generate a refresh pulse to turn on a low-side switch of a power converter once an off-time of the low-side switch exceeds a predetermined threshold, and a logic gate configured to receive the refresh pulse and a low-side pulse width modulation (PWM) signal, and generate a drive signal applied to a gate of the low-side switch of the power converter.

Optionally, in the preceding aspect, the power converter is a buck converter comprising a high-side switch and the low-side switch connected in series between an input voltage bus and ground, an inductor connected in series between a common node of the high-side switch and the low-side switch, and an output voltage bus, and an output capacitor connected between the output voltage bus and ground.

Optionally, in any of the preceding aspects, the logic gate is an OR gate, and the bootstrap capacitor refresh pulse generation circuit is a timer configured to measure duration of time after the low-side switch is turned off, and generate the refresh pulse once the off-time of the low-side switch exceeds the predetermined threshold, and wherein the low-side gate drive signal is fed into a first input of the OR gate, an output of the timer is fed into a second input of the OR gate, and an output of the OR gate is applied to the gate of the low-side switch through a low-side driver.

Optionally, in any of the preceding aspects, the logic gate is an OR gate, and the bootstrap capacitor refresh pulse generation circuit is a counter configured to count the number of clock cycles after the low-side switch is turned off, and generate the refresh pulse once the off-time of the low-side switch exceeds the predetermined threshold, and wherein the low-side gate drive signal is fed into a first input of the OR gate, an output of the counter is fed into a second input of the OR gate, and an output of the OR gate is applied to the gate of the low-side switch through a low-side driver.

Optionally, in any of the preceding aspects, the predetermined threshold is dynamically adjustable, and wherein the predetermined threshold is inversely related to a current flowing through the power converter.

Optionally, in any of the preceding aspects, a width of the refresh pulse is dynamically adjustable, and wherein the width of the refresh pulse is inversely related to a slope of a current flowing through the power converter.

Optionally, in any of the preceding aspects, a width of the refresh pulse is dynamically adjustable, and wherein the width of the refresh pulse is proportional to a difference between an output voltage of the power converter and a setpoint of the power converter.

Optionally, in any of the preceding aspects, a width of the refresh pulse is dynamically adjustable, and wherein the width of the refresh pulse is inversely related to a comp voltage of the power converter.

In accordance with another embodiment, a method comprises configuring a power conversion system to operate in a discontinuous conduction mode, wherein the power conversion system comprises a power converter connected between an input voltage bus and an output voltage bus, and a controller electrically coupled to the power converter, configuring a bootstrap capacitor refresh control apparatus to measure an off-time of a low-side switch of the power converter, and configuring the bootstrap capacitor refresh control apparatus to generate a refresh pulse to turn on the low-side switch of the power converter once the off-time of the low-side switch exceeds a predetermined threshold.

Optionally, in the preceding aspect, the method further comprises configuring a timer in the bootstrap capacitor refresh control apparatus to measure duration of time after the low-side switch is turned off, configuring the bootstrap capacitor refresh control apparatus to generate the refresh pulse once the off-time of the low-side switch exceeds the predetermined threshold, and resetting the timer once the low-side switch is turned on.

Optionally, in any of the preceding aspects, the bootstrap capacitor refresh control apparatus comprises an OR gate and the timer, and wherein a low-side PWM signal is fed into a first input of the OR gate, an output of the timer is fed into a second input of the OR gate, and an output of the OR gate is applied to a gate of the low-side switch through a low-side driver.

Optionally, in any of the preceding aspects, the method further comprises configuring a counter in the bootstrap capacitor refresh control apparatus to count the number of clock cycles after the low-side switch is turned off, configuring the bootstrap capacitor refresh control apparatus to generate the refresh pulse once the off-time of the low-side switch exceeds the predetermined threshold, and resetting the counter once the low-side switch is turned on.

Optionally, in any of the preceding aspects, the bootstrap capacitor refresh control apparatus comprises an OR gate and the counter, and wherein a low-side PWM signal is fed into a first input of the OR gate, an output of the counter is fed into a second input of the OR gate, and an output of the OR gate is applied to a gate of the low-side switch through a low-side driver.

Optionally, in any of the preceding aspects, the method further comprises dynamically adjusting the predetermined threshold based on a current flowing through the power converter.

Optionally, in any of the preceding aspects, the method further comprises dynamically adjusting a width of the refresh pulse based on a slope of a current flowing through the power converter.

Optionally, in any of the preceding aspects, the method further comprises dynamically adjusting a width of the refresh pulse based on a comp signal of the power converter.

Optionally, in any of the preceding aspects, the method further comprises determining a first width of the refresh pulse based on a slope of a current flowing through the power converter, and determining a second width of the refresh pulse based on a comp signal of the power converter, wherein a width of the refresh pulse is alternately set using the first width and the second width.

In accordance with yet another embodiment, a system comprises a power converter connected between an input voltage bus and an output voltage bus, and a controller electrically coupled to the power converter, wherein the controller comprises a bootstrap capacitor refresh control apparatus, and wherein the bootstrap capacitor refresh control apparatus is configured to measure an off-time of a low-side switch of the power converter, and the bootstrap capacitor refresh control apparatus is configured to generate a refresh pulse to turn on the low-side switch of the power converter once the off-time of the low-side switch exceeds a predetermined threshold.

Optionally, in the preceding aspect, the power converter comprises a high-side switch and the low-side switch connected in series between the input voltage bus and ground, an inductor connected in series between a common node of the high-side switch and the low-side switch, and the output voltage bus, and an output capacitor connected between the output voltage bus and ground.

Optionally, in any of the preceding aspects, the bootstrap capacitor refresh control apparatus comprises an OR gate and a timer, and wherein a low-side PWM signal is fed into a first input of the OR gate, an output of the timer is fed into a second input of the OR gate, and an output of the OR gate is applied to a gate of the low-side switch through a low-side driver.

Features described in the context of one embodiment may be used in combination with other embodiments. For example, each of the optional features described above in the context of the apparatus may be used in combination with the system. Each of the optional features described above in the context of the method may be used in combination with the system. Each of the optional features described above in the context of the apparatus may be used in combination with the method.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a block diagram of a power conversion system in accordance with various embodiments of the present disclosure;

FIG. 2 illustrates a schematic diagram of the power converter shown in FIG. 1 in accordance with various embodiments of the present disclosure;

FIG. 3 illustrates a schematic diagram of a first implementation of the bootstrap capacitor refresh control apparatus shown in FIG. 2 in accordance with various embodiments of the present disclosure;

FIG. 4 illustrates various signals associated with the bootstrap capacitor refresh control apparatus shown in FIG. 3 in accordance with various embodiments of the present disclosure;

FIG. 5 illustrates a schematic diagram of a second implementation of the bootstrap capacitor refresh control apparatus shown in FIG. 2 in accordance with various embodiments of the present disclosure;

FIG. 6 illustrates various signals associated with the bootstrap capacitor refresh control apparatus shown in FIG. 5 in accordance with various embodiments of the present disclosure;

FIG. 7 illustrates a schematic diagram of a third implementation and a fourth implementation of the bootstrap capacitor refresh control apparatus shown in FIG. 2 in accordance with various embodiments of the present disclosure;

FIG. 8 illustrates a schematic diagram of a fifth implementation of the bootstrap capacitor refresh control apparatus shown in FIG. 2 in accordance with various embodiments of the present disclosure;

FIG. 9 illustrates a schematic diagram of a sixth implementation of the bootstrap capacitor refresh control apparatus shown in FIG. 2 in accordance with various embodiments of the present disclosure;

FIG. 10 illustrates a schematic diagram of a seventh implementation of the bootstrap capacitor refresh control apparatus shown in FIG. 2 in accordance with various embodiments of the present disclosure; and

FIG. 11 illustrates a flow chart of a method for controlling the power conversion system shown in FIG. 1 in accordance with various embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

The present disclosure will be described with respect to embodiments in a specific context, namely a bootstrap capacitor refresh control apparatus for maintaining a bootstrap capacitor voltage in a buck converter. The disclosure may also be applied, however, to a variety of power converters. Hereinafter, various embodiments will be explained in detail with reference to the accompanying drawings.

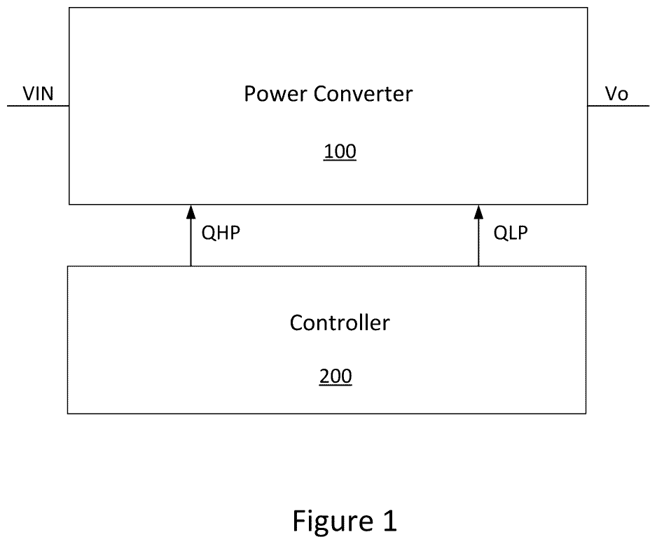

FIG. 1 illustrates a block diagram of a power conversion system in accordance with various embodiments of the present disclosure. The power conversion system comprises a power converter 100 and a controller 200. As shown in FIG. 1, the power converter 100 is connected between an input voltage bus VIN and an output voltage bus Vo. A load (not shown) is coupled to the output voltage bus Vo. In some embodiments, the load may be a processor (e.g., a central processing unit).

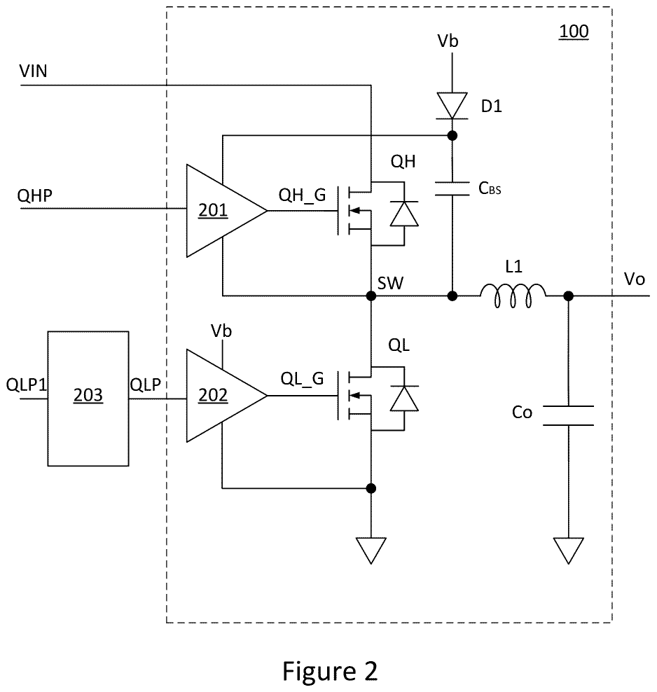

In some embodiments, the power converter 100 is implemented as a step-down power converter. The step-down power converter is formed by two power switches and an output filter. The two power switches include a high-side power switch and a low-side power switch connected in series between the input voltage bus VIN and ground. The high-side power switch and the low-side power switch are controlled to regulate the output voltage of the step-down power converter. The power converter 100 also includes the gate driver circuitry that controls the high-side and low-side power switches, optimizing the switching operation for speed and efficiency. The power converter 100 may further comprise other key components such as current sensing, temperature sensing and the like. The detailed structure of the power converter 100 will be described below with respect to FIG. 2.

In alternative embodiments, the power converter 100 may be implemented as any suitable power conversion topologies such as an inductor-inductor-capacitor (LLC) converter, a switched capacitor converter, a hybrid switched capacitor converter, a full bridge power converter, a half bridge power converter, a boost converter, a buck-boost converter any combinations thereof and the like.

As shown in FIG. 1, the controller 200 is electrically coupled to the power converter 100. In particular, the controller 200 is configured to generate PWM signals QHP and QLP to control the power converter 100. In operation, based on the output voltage Vo, the controller 200 generates the PWM signals QHP and QLP to regulate the output voltage Vo.

In some embodiments, the controller 200 may be a system controller or a system control apparatus. The controller 200 may be implemented as a microprocessor, a digital signal processor and the like.

In some embodiments, the controller 200 comprises a bootstrap capacitor refresh control apparatus. In some embodiments, the bootstrap capacitor refresh control apparatus comprises a bootstrap capacitor refresh pulse generation circuit and a logic gate. In some embodiments, the bootstrap capacitor refresh pulse generation circuit is implemented as a timer. The logic gate is implemented as an OR gate. In alternative embodiments, the bootstrap capacitor refresh pulse generation circuit is implemented as a counter.

It should be noted that the block diagram shown in FIG. 1 is merely an example, which should not unduly limit the scope of the claims. One of ordinary skill in the art would recognize many variations, alternatives, and modifications. For example, depending on different design needs, the power switches, the drivers and the controller may be integrated in one semiconductor package.

In operation, in order to maintain the voltage across the bootstrap capacitor, the bootstrap capacitor refresh control apparatus is configured to generate a low-side turn-on pulse once the off time of the low-side switch is greater than a predetermined threshold.

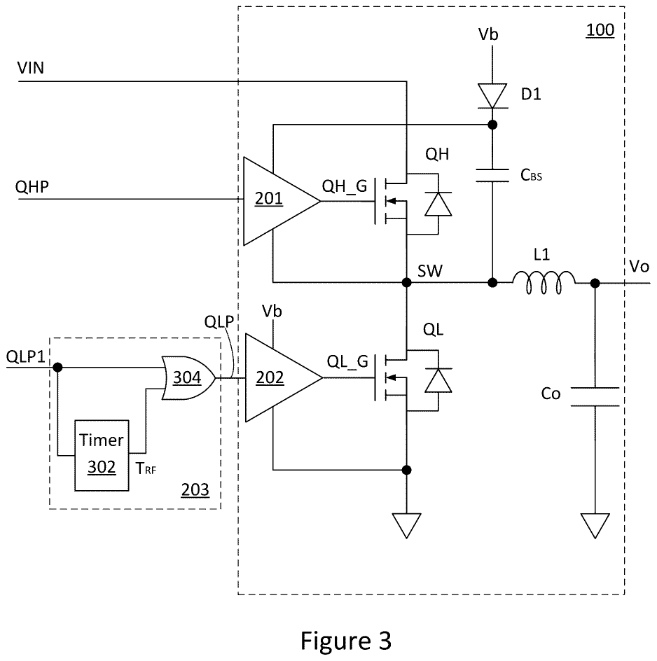

At least seven control methods can be used to maintain the voltage across the bootstrap capacitor. These seven control methods will be described in detail below with respect to FIGS. 3-10.

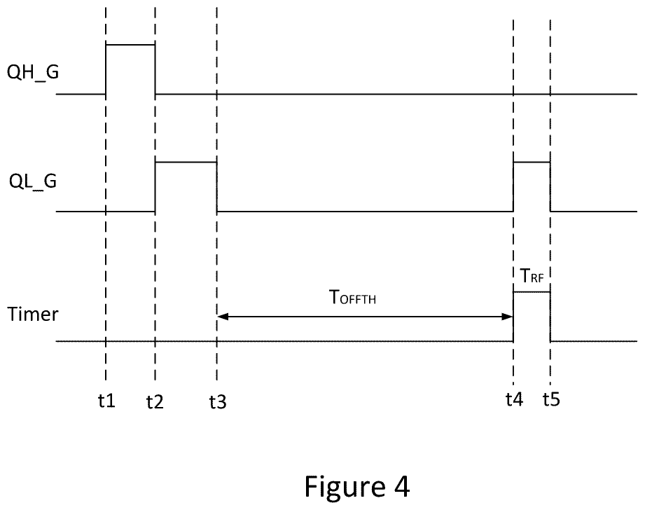

In a first implementation of the control methods, the bootstrap capacitor refresh pulse generation circuit comprises a timer. The timer is configured to measure the off time of the low-side switch. Once the off time of the low-side switch is greater than a predetermined threshold, the bootstrap capacitor refresh pulse generation circuit is configured to generate a bootstrap capacitor refresh pulse to turn on the low-side switch. As a result of turning on the low-side switch, the bias voltage charges the bootstrap capacitor, thus replenishing the bootstrap capacitor. The detailed operating principle of the first implementation will be described below with respect to FIGS. 3-4.

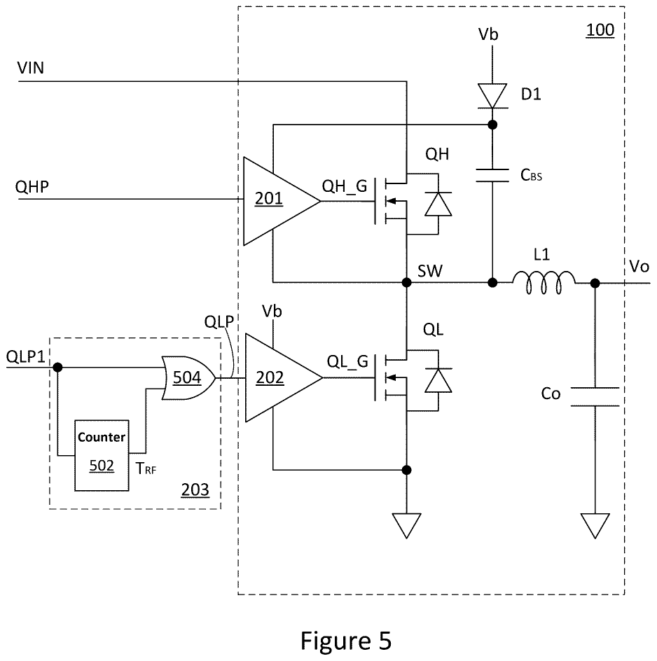

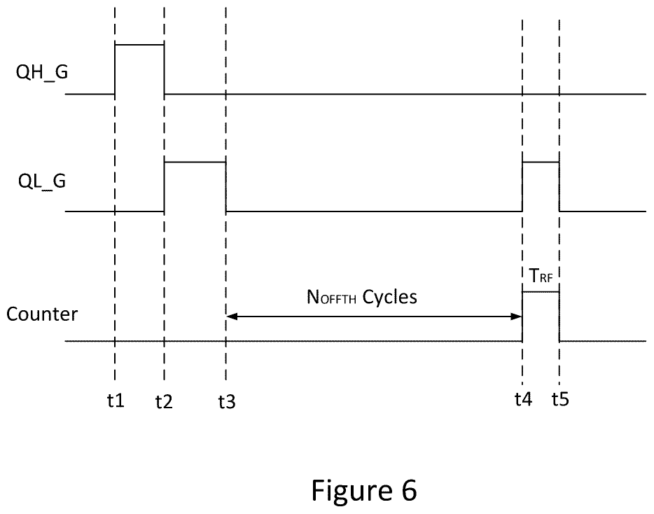

In a second implementation of the control methods, the bootstrap capacitor refresh pulse generation circuit comprises a counter. The counter is configured to count the clock cycles in which the low-side switch remains off. Once the number of the clock cycles is greater than a predetermined threshold, the bootstrap capacitor refresh pulse generation circuit is configured to generate a bootstrap capacitor refresh pulse to turn on the low-side switch. As a result of turning on the low-side switch, the bias voltage charges the bootstrap capacitor, thus replenishing the bootstrap capacitor. The detailed operating principle of the second implementation will be described below with respect to FIGS. 5-6.

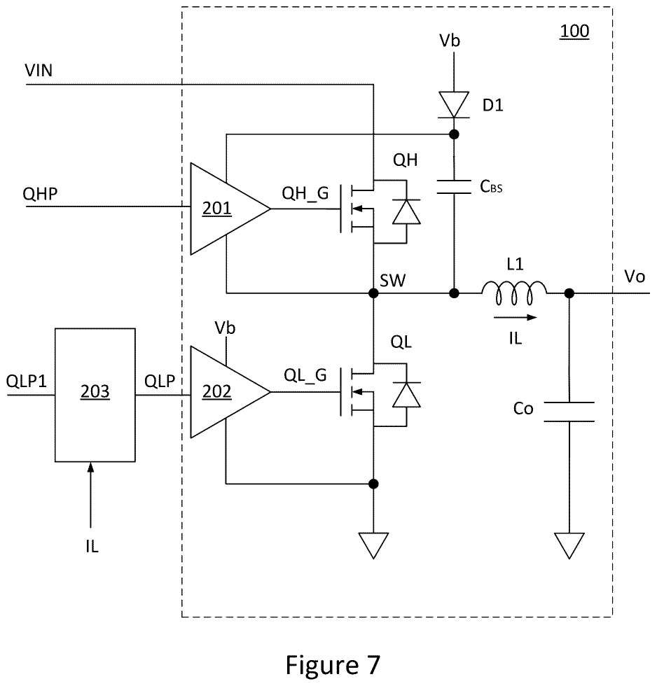

In a third implementation of the control methods, the bootstrap capacitor refresh pulse generation circuit comprises a timer or a counter. Once the off time of the low-side switch is greater than a predetermined threshold, the bootstrap capacitor refresh pulse generation circuit is configured to generate a bootstrap capacitor refresh pulse to turn on the low-side switch. In operation, the predetermined threshold is dynamically adjustable. More particularly, the predetermined threshold is adjusted based on the current flowing through the power converter 100. The detailed operating principle of the third implementation will be described below with respect to FIG. 7.

In a fourth implementation of the control methods, the bootstrap capacitor refresh pulse generation circuit comprises a timer or a counter. Once the off time of the low-side switch is greater than a predetermined threshold, the bootstrap capacitor refresh pulse generation circuit is configured to generate a bootstrap capacitor refresh pulse to turn on the low-side switch. In operation, the width of the bootstrap capacitor refresh pulse is dynamically adjustable. More particularly, the width of the bootstrap capacitor refresh pulse is adjusted based on a slope of the current flowing through the power converter 100. The detailed operating principle of the fourth implementation will be described below with respect to FIG. 7.

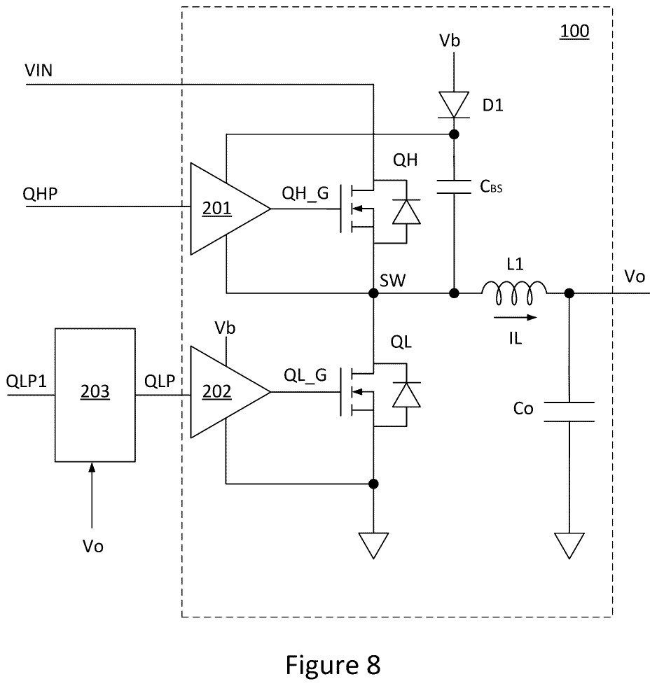

In a fifth implementation of the control methods, the bootstrap capacitor refresh pulse generation circuit comprises a timer or a counter. Once the off time of the low-side switch is greater than a predetermined threshold, the bootstrap capacitor refresh pulse generation circuit is configured to generate a bootstrap capacitor refresh pulse to turn on the low-side switch. In operation, the width of the bootstrap capacitor refresh pulse is dynamically adjustable. More particularly, the width of the bootstrap capacitor refresh pulse is adjusted based on the output voltage of the power converter 100. The detailed operating principle of the fifth implementation will be described below with respect to FIG. 8.

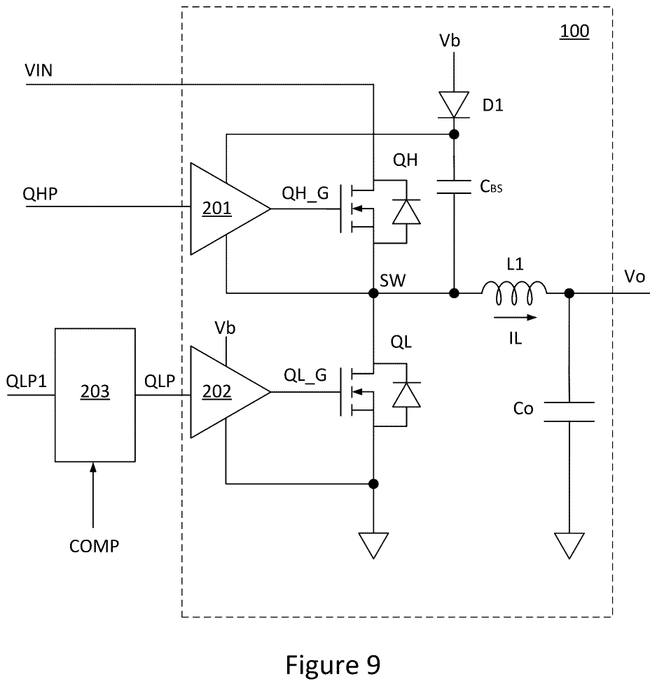

In a sixth implementation of the control methods, the bootstrap capacitor refresh pulse generation circuit comprises a timer or a counter. Once the off time of the low-side switch is greater than a predetermined threshold, the bootstrap capacitor refresh pulse generation circuit is configured to generate a bootstrap capacitor refresh pulse to turn on the low-side switch. In operation, the width of the bootstrap capacitor refresh pulse is dynamically adjustable. More particularly, the width of the bootstrap capacitor refresh pulse is adjusted based on a compensation (comp) signal of the power converter 100. The detailed operating principle of the sixth implementation will be described below with respect to FIG. 9.

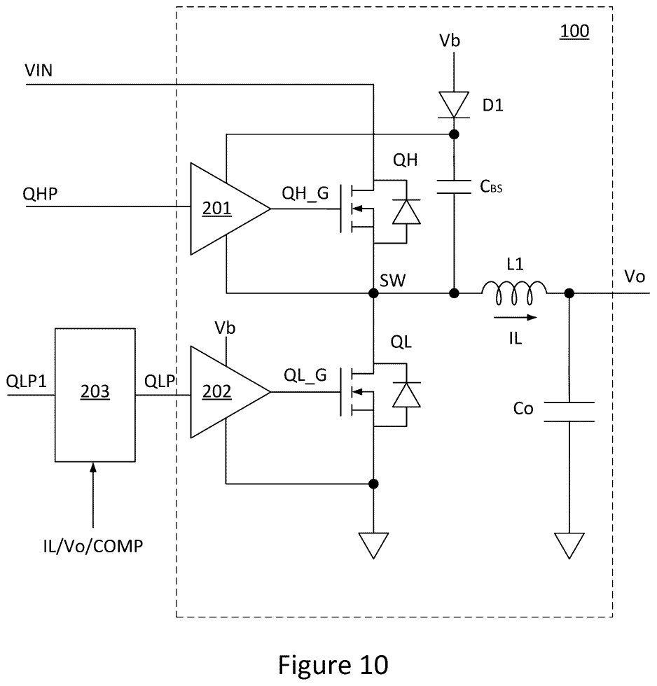

In a seventh implementation of the control methods, the bootstrap capacitor refresh pulse generation circuit comprises a timer or a counter. Once the off time of the low-side switch is greater than a predetermined threshold, the bootstrap capacitor refresh pulse generation circuit is configured to generate a bootstrap capacitor refresh pulse to turn on the low-side switch. In operation, the width of the bootstrap capacitor refresh pulse is dynamically adjustable. More particularly, the width of the bootstrap capacitor refresh pulse is adjusted based on a combination of the fourth implementation, the fifth implementation and the sixth implementation. The detailed operating principle of the seventh implementation will be described below with respect to FIG. 10.

FIG. 2 illustrates a schematic diagram of the power converter shown in FIG. 1 in accordance with various embodiments of the present disclosure. The power converter 100 is a step-down power converter. The step-down power converter comprises a high-side switch QH, a low-side switch QL, an output inductor L1 and an output capacitor Co. As shown in FIG. 2, the high-side switch QH and the low-side switch QL are connected in series between the input voltage bus VIN and ground. The output inductor L1 is connected between a common node (SW) of the high-side switch QH and the low-side switch QL, and the output voltage bus Vo. The output capacitor Co is connected between the output voltage bus Vo and ground.

The power converter 100 further comprises a high-side driver 201, a low-side driver 202, a bootstrap capacitor C_{BS} and a diode D1. The diode D1 and the bootstrap capacitor C_{BS} are connected in series between a bias voltage Vb and a common node of QH and QL. The positive supply terminal of the high-side driver 201 is connected to a common node of the diode D1 and the bootstrap capacitor C_{BS}. The negative supply terminal of the high-side driver 201 is connected to the common node of QH and QL. The positive supply terminal of the low-side driver 202 is connected to the bias voltage Vb. The negative supply terminal of the low-side driver 202 is connected to ground.

A high-side driver 201 is configured to receive a high-side PWM signal QHP from the controller 200. Based on the received signal, the high-side driver 201 generates a high-side gate drive signal QH_G applied to the gate of the high-side switch QH through the high-side driver 201.

A bootstrap capacitor refresh control apparatus 203 is configured to receive a low-side PWM signal QLP1 from the controller 200. Based on the low-side PWM signal QLP1, the bootstrap capacitor refresh control apparatus 203 is configured to generate a modified low-side PWM signal QLP fed into a low-side driver 202. Based on the received signal, the low-side driver 202 generates a low-side gate drive signal QL_G for the low-side switch QL.

In operation, when the high-side switch QH is turned on, and the low-side switch QL is turned off, a current flows from the input voltage VIN to the load through the output inductor L1. The output inductor L1 opposes sudden changes in current by storing energy in its magnetic field. The output capacitor Co supplies the load with current, smoothing out the output voltage Vo. When the high-side switch QH is turned off, and the low-side switch QL is turned on, the output inductor L1 releases its stored energy to maintain the current flow to the load. The output capacitor Co continues to smooth the output voltage. In operation, the duty cycle (the ratio of the turn-on time of the high-side switch QH to the total switching period) is used to control the output voltage Vo. By adjusting the duty cycle, the output voltage Vo can be regulated at a predetermined level.

In accordance with an embodiment, the switches (e.g., switches QH and QL) may be metal oxide semiconductor field-effect transistor (MOSFET) devices. Alternatively, the switches can be any controllable switches such as insulated gate bipolar transistor (IGBT) devices, integrated gate commutated thyristor (IGCT) devices, gate turn-off thyristor (GTO) devices, silicon-controlled rectifier (SCR) devices, junction gate field-effect transistor (JFET) devices, MOS controlled thyristor (MCT) devices, gallium nitride (GaN)-based power devices, silicon carbide (SiC)-based power devices and the like.

It should be noted while FIG. 2 shows the switches QH and QL are implemented as single n-type transistors, a person skilled in the art would recognize there may be many variations, modifications and alternatives. For example, depending on different applications and design needs, the switches QH and QL may be implemented as p-type transistors. Furthermore, each switch shown in FIG. 2 may be implemented as a plurality of switches connected in parallel. Moreover, a capacitor may be connected in parallel with one switch to achieve zero voltage switching (ZVS)/zero current switching (ZCS).

FIG. 3 illustrates a schematic diagram of a first implementation of the bootstrap capacitor refresh control apparatus shown in FIG. 2 in accordance with various embodiments of the present disclosure. The bootstrap capacitor refresh control apparatus 203 comprises a logic gate 304 and a timer 302. In some embodiments, the logic gate 304 is an OR gate. The timer 302 is implemented as any suitable timers. The timer 302 functions as a bootstrap capacitor refresh pulse generation circuit. As shown in FIG. 3, the low-side PWM signal QLP1 generated by the controller is fed into a first input of the OR gate 304 and an input of the timer 302. The output of the timer 302 is fed into a second input of the OR gate 304. The output of the OR gate 304 is applied to the gate of the low-side switch QL through the low-side driver 202.

In operation, when both QH and QL switch in each cycle, the voltage across the bootstrap capacitor maintains an adequate voltage. The low-side PWM signal QLP1 is routed through the OR gate 304 and delivered to the gate of QL via the low-side driver 202. The timer 302 is triggered by the falling edge of the low-side PWM signal QLP1. Since the low-side switch QL turns on before a predetermined threshold is reached, the timer 302 resets at the end of each PWM cycle, preventing it from generating a refresh pulse.

In light-load conditions, such as during discontinuous mode operation, the timer 302 is able to generate a refresh pulse to turn on the low-side switch QL when the off time of QL exceeds the predetermined threshold. More particularly, when the low-side switch QL turns off, the timer 302 is triggered by the falling edge of the low-side PWM signal QLP1. If the low-side switch QL remains off long enough to exceed the predetermined threshold, the output of the timer 302 generates a refresh pulse to turn on the low-side switch QL through the OR gate 304 and the low-side driver 202. This process enables the bootstrap capacitor refresh control apparatus 203 to measure the duration since the low-side switch turns off, issuing a refresh pulse once this off time of the low-side switch QL exceeds the predetermined threshold.

FIG. 4 illustrates various signals associated with the bootstrap capacitor refresh control apparatus shown in FIG. 3 in accordance with various embodiments of the present disclosure. The horizontal axis represents intervals of time. There are three rows. The first row represents the gate drive signal (QH_G) of the high-side switch QH. The second row represents the gate drive signal (QL_G) of the low-side switch QL. The third row represents the output signal of the timer.

At t1, the gate drive signal QH_G of the high-side switch changes from a logic low state to a logic high state. In response to this change, the high-side switch QH is turned on. The current flowing through the inductor L1 increases in a linear manner from t1 to t2.

At t2, the high-side switch QH is turned off, and the low-side switch QL is turned on. The current flowing through the inductor L1 decreases in a linear manner from t2 to t3. As shown in FIG. 3, at t3, the low-side switch QL is turned off. From t3, the power conversion system operates in the discontinuous conduction mode. From t3 to t4, both the high-side switch QH and the low-side switch QL are turned off. At t3, the timer starts measuring the off time of the low-side switch QL from the falling edge of the low-side gate drive signal QL_G.

At t4, the off time of the low-side switch QL reaches a predetermined threshold T_{OFFTH}. The output of the timer 302 generates a refresh pulse T_{RF}. Referring back to FIG. 3, the refresh pulse T_{RF} is applied to the gate of the low-side switch QL through the OR gate 304 and the low-side driver 202. As a result, the low-side gate drive signal QL_G is of a logic high state from t4 to t5. The low-side switch QL turns on from t4 to t5. Once the low-side switch QL turns on, the bootstrap capacitor C_{BS} is replenished by the bias voltage Vb, and the timer is reset. Afte t5, the process described above is repeated.

FIG. 5 illustrates a schematic diagram of a second implementation of the bootstrap capacitor refresh control apparatus shown in FIG. 2 in accordance with various embodiments of the present disclosure. The second implementation is similar to the first implementation shown in FIG. 3 except that the timer is replaced by a counter. As shown in FIG. 5, the low-side PWM signal QLP1 generated by the controller is fed into a first input of an OR gate 504 and an input of the counter 502. The output of the counter 502 is fed into a second input of the OR gate 504. The output of the OR gate 504 is applied to the gate of the low-side switch QL through the low-side driver 202.

In light-load conditions, such as during discontinuous mode operation, the counter 502 is able to generate a refresh pulse to turn on QL if the off time of the low-side switch QL exceeds the predetermined threshold. More particularly, when the low-side switch QL turns off, the counter 502 starts to count clock cycles. Once the number of clock cycles reaches a predetermined value, the output of the counter 502 generates a refresh pulse T_{RF} to turn on the low-side switch QL through the OR gate 304 and the low-side driver 202.

In some embodiments, the counter 502 operates with a clock. The predetermined number is determined by dividing the predetermined threshold by the time period of the clock.

FIG. 6 illustrates various signals associated with the bootstrap capacitor refresh control apparatus shown in FIG. 5 in accordance with various embodiments of the present disclosure. The horizontal axis represents intervals of time. There are three rows. The first row represents the gate drive signal (QH_G) of the high-side switch QH. The second row represents the gate drive signal (QL_G) of the low-side switch QL. The third row represents the output signal of the counter.

At t1, the gate drive signal QH_G of the high-side switch changes from a logic low state to a logic high state. In response to this change, the high-side switch QH is turned on. The current flowing through the inductor L1 increases in a linear manner from t1 to t2.

At t2, the high-side switch QH is turned off, and the low-side switch QL is turned on. The current flowing through the inductor L1 decreases in a linear manner from t2 to t3. As shown in FIG. 5, at t3, the low-side switch QL is turned off. From t3, the power conversion system operates in the discontinuous conduction mode. From t3 to t4, both the high-side switch QH and the low-side switch QL are turned off. At t3, the counter starts counting clock cycles from the falling edge of the low-side gate drive signal QL_G.

At t4, the number of clock cycles reaches a predetermined number N_{OFFTH}. The output of the counter generates a refresh pulse T_{RF}. Referring back to FIG. 5, the refresh pulse T_{RF} is applied to the gate of the low-side switch QL through the OR gate 504 and the low-side driver 202. As a result, the low-side gate drive signal QL_G is of a logic high state from t4 to t5. The low-side switch QL turns on from t4 to t5. Once the low-side switch QL turns on, the bootstrap capacitor C_{BS} is replenished by the bias voltage Vb, and the counter is reset. Afte t5, the process described above is repeated.

FIG. 7 illustrates a schematic diagram of a third implementation and a fourth implementation of the bootstrap capacitor refresh control apparatus shown in FIG. 2 in accordance with various embodiments of the present disclosure. As shown in FIG. 7, the bootstrap capacitor refresh control apparatus 203 is configured to receive the current IL flowing through the power converter 100. The current is used to dynamically adjust the predetermined threshold in the third implementation. Additionally, a slope of the current is used to dynamically adjust the width of the refresh pulse in the fourth implementation.

In the third implementation, the predetermined threshold (e.g., time threshold for a timer) is dynamically adjustable. In some embodiments, the predetermined threshold is inversely proportional to a current flowing through the power converter 100. For example, in light-load conditions, the current flowing through the power converter 100 is in a range from 1 mA to 100 mA. The predetermined threshold at 1 mA is about 100 times greater than that at 100 mA. In alternative embodiments, the predetermined threshold is inversely related to the current flowing through the power converter 100. For example, as the current flowing through the power converter 100 increases, the refresh pulse width decreases, and as the current flowing through the power converter 100 decreases, the refresh pulse width increases.

In the fourth implementation, the refresh pulse width can be adjusted dynamically. In some embodiments, this pulse width is inversely related to the slope of the current flowing through the power converter 100. In other words, as the slope of the current increases, the refresh pulse width decreases, and as the slope of the current decreases, the refresh pulse width increases.

An advantage of dynamically adjusting the refresh pulse width is that reducing the pulse width when the current slope increases can help minimize the effect of turning on the low-side switch on the output voltage. Conversely, increasing the pulse width at a higher slope enables full recharging of the bootstrap capacitor C_{BS}.

FIG. 8 illustrates a schematic diagram of a fifth implementation of the bootstrap capacitor refresh control apparatus shown in FIG. 2 in accordance with various embodiments of the present disclosure. As shown in FIG. 8, the bootstrap capacitor refresh control apparatus 203 is configured to receive the output voltage Vo of the power converter 100. The output voltage Vo is used to dynamically adjust the width of the refresh pulse.

In some embodiments, the pulse width is proportional to the difference between the output voltage and the setpoint of the power converter 100. Under light load conditions, the output voltage may exceed this setpoint. Upon detecting an elevated output voltage, the pulse width is increased to ensure full recharging of the bootstrap capacitor.

FIG. 9 illustrates a schematic diagram of a sixth implementation of the bootstrap capacitor refresh control apparatus shown in FIG. 2 in accordance with various embodiments of the present disclosure. As shown in FIG. 9, the bootstrap capacitor refresh control apparatus 203 is configured to receive a comp signal COMP of the power converter 100. The comp signal is used to dynamically adjust the width of the refresh pulse.

In some embodiments, the comp signal is tapped at an output of an error amplifier. An inverting input of the error amplifier is connected to the output of the power converter 100 through a resistor divider. A non-inverting input of the error amplifier is configured to receive a predetermined reference. A compensation network is coupled between the output of the error amplifier and ground.

The width of the refresh pulse is dynamically adjustable. In some embodiments, the width of the refresh pulse is inversely related to the voltage of the comp signal. In other words, as the voltage of the comp signal increases, the refresh pulse width decreases, and as the voltage of the comp signal decreases, the refresh pulse width increases.

FIG. 10 illustrates a schematic diagram of a seventh implementation of the bootstrap capacitor refresh control apparatus shown in FIG. 2 in accordance with various embodiments of the present disclosure. As shown in FIG. 10, the bootstrap capacitor refresh control apparatus 203 is configured to receive the current IL flowing through the power converter 100, the output voltage Vo and the comp signal COMP. In some embodiment, a first width of the refresh pulse is determined based on a slope of the current flowing through the power converter 100. A second width of the refresh pulse is determined based on the comp signal of the power converter 100. In order to further improve the performance of the bootstrap capacitor refresh control apparatus 203, a width of the refresh pulse is alternately set using the first width and the second width.

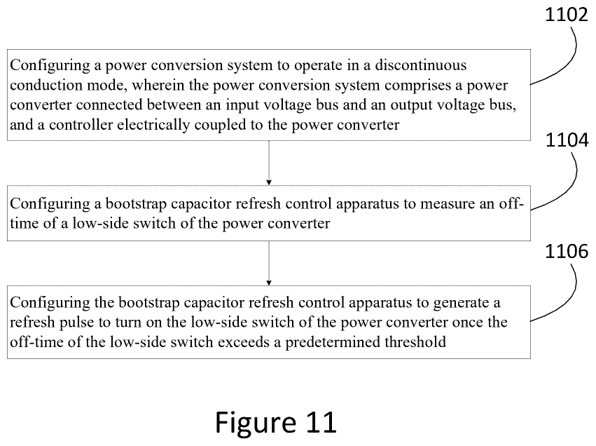

FIG. 11 illustrates a flow chart of a method for controlling the power conversion system shown in FIG. 1 in accordance with various embodiments of the present disclosure. This flowchart shown in FIG. 11 is merely an example, which should not unduly limit the scope of the claims. One of ordinary skill in the art would recognize many variations, alternatives, and modifications. For example, various steps illustrated in FIG. 11 may be added, removed, replaced, rearranged and repeated.

At step 1102, a power conversion system is configured to operate in a discontinuous conduction mode, wherein the power conversion system comprises a power converter connected between an input voltage bus and an output voltage bus, and a controller electrically coupled to the power converter.

At step 1104, a bootstrap capacitor refresh control apparatus is configured to measure an off-time of a low-side switch of the power converter.

At step 1106, the bootstrap capacitor refresh control apparatus is configured to generate a refresh pulse to turn on the low-side switch of the power converter once the off-time of the low-side switch exceeds a predetermined threshold.

The method further comprises configuring a timer in the bootstrap capacitor refresh control apparatus to measure duration of time after the low-side switch is turned off, configuring the bootstrap capacitor refresh control apparatus to generate the refresh pulse once the off-time of the low-side switch exceeds the predetermined threshold, and resetting the timer once the low-side switch is turned on.

In some embodiments, the bootstrap capacitor refresh control apparatus comprises an OR gate and the timer, and wherein a low-side PWM signal is fed into a first input of the OR gate, an output of the timer is fed into a second input of the OR gate, and an output of the OR gate is applied to a gate of the low-side switch through a low-side driver.

The method further comprises configuring a counter in the bootstrap capacitor refresh control apparatus to count the number of clock cycles after the low-side switch is turned off, configuring the bootstrap capacitor refresh control apparatus to generate the refresh pulse once the off-time of the low-side switch exceeds the predetermined threshold, and resetting the counter once the low-side switch is turned on.

In some embodiments, the bootstrap capacitor refresh control apparatus comprises an OR gate and the counter, and wherein a low-side PWM signal is fed into a first input of the OR gate, an output of the counter is fed into a second input of the OR gate, and an output of the OR gate is applied to a gate of the low-side switch through a low-side driver.

The method further comprises dynamically adjusting the predetermined threshold based on a current flowing through the power converter.

The method further comprises dynamically adjusting a width of the refresh pulse based on a slope of a current flowing through the power converter.

The method further comprises dynamically adjusting a width of the refresh pulse based on a comp signal of the power converter.

The method further comprises determining a first width of the refresh pulse based on a slope of a current flowing through the power converter, and determining a second width of the refresh pulse based on a comp signal of the power converter, wherein a width of the refresh pulse is alternately set using the first width and the second width.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, which may perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

What is claimed is:

1. An apparatus comprising:
a bootstrap capacitor refresh pulse generation circuit configured to generate a refresh pulse to turn on a low-side switch of a power converter once an off-time of the low-side switch exceeds a predetermined threshold; and
a logic gate configured to receive the refresh pulse and a low-side pulse width modulation (PWM) signal, and generate a drive signal applied to a gate of the low-side switch of the power converter.

2. The apparatus of claim 1, wherein the power converter is a buck converter comprising:
a high-side switch and the low-side switch connected in series between an input voltage bus and ground;
an inductor connected in series between a common node of the high-side switch and the low-side switch, and an output voltage bus; and
an output capacitor connected between the output voltage bus and ground.

3. The apparatus of claim 1, wherein:
the logic gate is an OR gate; and
the bootstrap capacitor refresh pulse generation circuit is a timer configured to measure duration of time after the low-side switch is turned off, and generate the refresh pulse once the off-time of the low-side switch exceeds the predetermined threshold, and wherein:
the low-side gate drive signal is fed into a first input of the OR gate;
an output of the timer is fed into a second input of the OR gate; and
an output of the OR gate is applied to the gate of the low-side switch through a low-side driver.

4. The apparatus of claim 1, wherein:
the logic gate is an OR gate; and
the bootstrap capacitor refresh pulse generation circuit is a counter configured to count the number of clock cycles after the low-side switch is turned off, and generate the refresh pulse once the off-time of the low-side switch exceeds the predetermined threshold, and wherein:
the low-side gate drive signal is fed into a first input of the OR gate;
an output of the counter is fed into a second input of the OR gate; and
an output of the OR gate is applied to the gate of the low-side switch through a low-side driver.

5. The apparatus of claim 1, wherein:
the predetermined threshold is dynamically adjustable, and wherein the predetermined threshold is inversely related to a current flowing through the power converter.

6. The apparatus of claim 1, wherein:
a width of the refresh pulse is dynamically adjustable, and wherein the width of the refresh pulse is inversely related to a slope of a current flowing through the power converter.

7. The apparatus of claim 1, wherein:
a width of the refresh pulse is dynamically adjustable, and wherein the width of the refresh pulse is proportional to a difference between an output voltage of the power converter and a setpoint of the power converter.

8. The apparatus of claim 1, wherein:
a width of the refresh pulse is dynamically adjustable, and wherein the width of the refresh pulse is inversely related to a comp voltage of the power converter.

9. A method comprising:
configuring a power conversion system to operate in a discontinuous conduction mode, wherein the power conversion system comprises a power converter connected between an input voltage bus and an output voltage bus, and a controller electrically coupled to the power converter;
configuring a bootstrap capacitor refresh control apparatus to measure an off-time of a low-side switch of the power converter; and
configuring the bootstrap capacitor refresh control apparatus to generate a refresh pulse to turn on the low-side switch of the power converter once the off-time of the low-side switch exceeds a predetermined threshold.

10. The method of claim 9, further comprising:
configuring a timer in the bootstrap capacitor refresh control apparatus to measure duration of time after the low-side switch is turned off;
configuring the bootstrap capacitor refresh control apparatus to generate the refresh pulse once the off-time of the low-side switch exceeds the predetermined threshold; and
resetting the timer once the low-side switch is turned on.

11. The method of claim 10, wherein the bootstrap capacitor refresh control apparatus comprises an OR gate and the timer, and wherein:
a low-side PWM signal is fed into a first input of the OR gate;
an output of the timer is fed into a second input of the OR gate; and
an output of the OR gate is applied to a gate of the low-side switch through a low-side driver 12. The method of claim 9, further comprising:
configuring a counter in the bootstrap capacitor refresh control apparatus to count the number of clock cycles after the low-side switch is turned off;
configuring the bootstrap capacitor refresh control apparatus to generate the refresh pulse once the off-time of the low-side switch exceeds the predetermined threshold; and
resetting the counter once the low-side switch is turned on.

13. The method of claim 12, wherein the bootstrap capacitor refresh control apparatus comprises an OR gate and the counter, and wherein:
a low-side PWM signal is fed into a first input of the OR gate;
an output of the counter is fed into a second input of the OR gate; and
an output of the OR gate is applied to a gate of the low-side switch through a low-side driver.

14. The method of claim 9, further comprising:
dynamically adjusting the predetermined threshold based on a current flowing through the power converter.

15. The method of claim 9, further comprising:
dynamically adjusting a width of the refresh pulse based on a slope of a current flowing through the power converter.

16. The method of claim 9, further comprising:
dynamically adjusting a width of the refresh pulse based on a comp signal of the power converter.

17. The method of claim 9, further comprising:
determining a first width of the refresh pulse based on a slope of a current flowing through the power converter; and
determining a second width of the refresh pulse based on a comp signal of the power converter, wherein a width of the refresh pulse is alternately set using the first width and the second width.

18. A system comprising:
a power converter connected between an input voltage bus and an output voltage bus; and
a controller electrically coupled to the power converter, wherein the controller comprises a bootstrap capacitor refresh control apparatus, and wherein:
the bootstrap capacitor refresh control apparatus is configured to measure an off-time of a low-side switch of the power converter; and
the bootstrap capacitor refresh control apparatus is configured to generate a refresh pulse to turn on the low-side switch of the power converter once the off-time of the low-side switch exceeds a predetermined threshold.

19. The system of claim 18, wherein the power converter comprises:
a high-side switch and the low-side switch connected in series between the input voltage bus and ground;
an inductor connected in series between a common node of the high-side switch and the low-side switch, and the output voltage bus; and
an output capacitor connected between the output voltage bus and ground.

20. The system of claim 18, wherein:
the bootstrap capacitor refresh control apparatus comprises an OR gate and a timer, and wherein:
a low-side PWM signal is fed into a first input of the OR gate;
an output of the timer is fed into a second input of the OR gate; and
an output of the OR gate is applied to a gate of the low-side switch through a low-side driver.
